(19) United States
(12) Patent Application Publication
(10) Pub. No.: US 2008/0301497 A1
(43) Pub. Date: Dec. 4, 2008

(54) Testing Apparatus, System, and Method for Testing at Least One Device with a Connection Interface

(75) Inventors: Ming-Kun Chung, Miaoli Hsien (TW); Chang-Hao Chiang, Hsinchu City (TW); Kuo-Tung Huang, Miaoli Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Jhubei City (TW)

(21) Appl. No.: 12/023,070

(22) Filed: Jan. 31, 2008

Related U.S. Application Data
(60) Provisional application No. 60/941,720, filed on Jun. 4, 2007.

(51) Int. Cl. G06F 11/00

(52) U.S. Cl. 714/22; 714/E11.001

(57) ABSTRACT

A system, a testing apparatus, and a method for testing at least one device with a connection interface are provided. The system comprises a host, a testing apparatus, and a power supply. The testing apparatus further comprises a microprocessor and at least one current limit module. The host sending a test signal. The power supply provides a voltage to the testing apparatus. The at least one current limit module of the testing apparatus, which is electrically connected to the microprocessor, the at least one device, and the power supply, provides the voltage to the at least one device. When the current passing through the at least one device is greater than the predetermined value, the at least one current limit module of the testing apparatus stops providing the voltage to the at least one device and sends an over current signal to the host via the microprocessor.

This application claims the benefit of Provisional Application Ser. No. 60/941,720 filed on Jun. 4, 2007.

### CROSS-REFERENCES TO RELATED APPLICATIONS

Not Applicable

### BACKGROUND OF THE INVENTION

1. Field of the Invention

The present invention relates to a testing apparatus, a system, and a method for testing at least one device with a connection interface; more specifically, the present invention relates to a testing apparatus, a system, and a method for testing at least one device with a connection interface by sensing an over current.

2. Descriptions of the Related Art

As capacity and utility of devices using the universal serial bus (USB) connection interfaces or the IEEE 1394 connection interfaces are improved, the prices thereof are becoming more reasonable. Devices with the foregoing interfaces are popular, such as flash memory card readers, USB flash drives (UFDs), and portable hard drives. These devices are adaptable to computer USB ports.

After the devices with the connection interfaces are manufactured, they have to be tested to control the quality of the products. The test includes an open test, short test, as well as functional tests, which include a writing test, reading test, self-test, code setting, or updating firmware.

A conventional method and testing system for testing devices with connection interfaces is one that uses a host (such as a computer) that also has connection interfaces so that the two may be connected for executing all tests. The connection interfaces may be USB connection interfaces and/or IEEE 1394 connection interfaces. In the ideal test condition, both the open/short (over current fail) tests and functional tests should be implemented for testing devices with an USB or IEEE 1394 connection interface. However, if both the aforementioned tests need to be implemented, one test machine will be used to do the open/short tests and the other test machine needs to be used to execute functional tests. Using two test machines is time consuming. Therefore, in the traditional test methodology, open/short tests are omitted. Since all tested devices need to be tested at the same time in the traditional test methodology, omitting open/short tests (also known as the over current fail test) will cause the system to shut down and stop testing other tested devices. Thus, the testing process can not be accomplished when at least one tested devices suffers from an over current failure.

A conventional testing system 1 for testing devices with a connection interface is illustrated in FIG. 1. The connection interface is the USB connection interface or the IEEE 1394 connection interface, etc. The host 11 connects to a plurality of tested devices 101, 102, 103, . . . , 126 at the same time so that the tested devices can be tested via the connection interface. Since the host 11 can only provide disk letters from A to Z, there cannot be more than 26 tested devices that are tested by the host 11 at the same time. In addition, in the traditional test methodology of the testing system 1, the tested device(s) that fail the test cannot be isolated, because all of the devices are tested at once.

Therefore, it is important to invent a testing system that can test devices with connection interfaces, that is cost effective, and that will not be interrupted by device failures.

### SUMMARY OF THE INVENTION

An objective of this invention is to provide a method for a testing apparatus to test at least one device with a connection interface. The testing apparatus comprises a microprocessor and at least one current limit module. The at least one current limit module is electrically connected to the microprocessor, while the at least one current limit module provides a voltage to at least one device. When a current that passes through at least one device is greater than a predetermined value, the at least one current limit module stops providing the voltage to at least one device and sends an over current signal to the microprocessor.

Another objective of this invention is to provide a system, which comprises a host, a testing apparatus, and a power supply, for testing at least one device with a connection interface. The host sends a test signal. The testing apparatus, which is electrically connected to the host, provides a voltage to at least one device after receiving the testing signal. The power supply is used to send a voltage to the testing apparatus. When a current passing through at least one device is greater than a predetermined value, the testing apparatus stops providing the voltage to at least one device and sends an over current signal to the host.

Yet another objective of this invention is to provide a method for testing at least one device with a connection interface. The method comprises the following steps: sending a test signal; providing a voltage to the least one device after receiving the test signal; determining whether a current passing through the at least one device is over a predetermined value; if yes, stopping providing the voltage to the at least one device; and sending a over current signal. If the current passing through the at least one device is determined not over the predetermined value, the method further comprises the following steps: executing a firmware update for the at least one device; and executing a reading/writing test for the at least one device.

With the aforementioned arrangement, the present invention is able to provide a testing apparatus and a system for testing devices with connection interfaces that is cost effective and that will not be interrupted by test failures.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a block diagram of a conventional testing system;

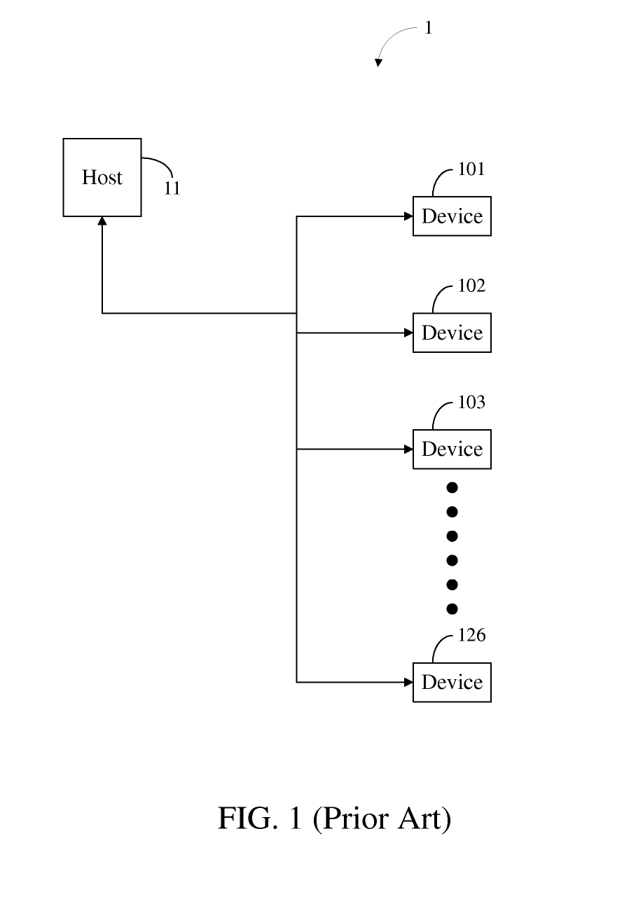

FIG. 2 illustrates a block diagram of a first embodiment of the present invention; and

FIG. 3 illustrates a flowchart of a second embodiment of the present invention.

### DESCRIPTION OF THE PREFERRED EMBODIMENT

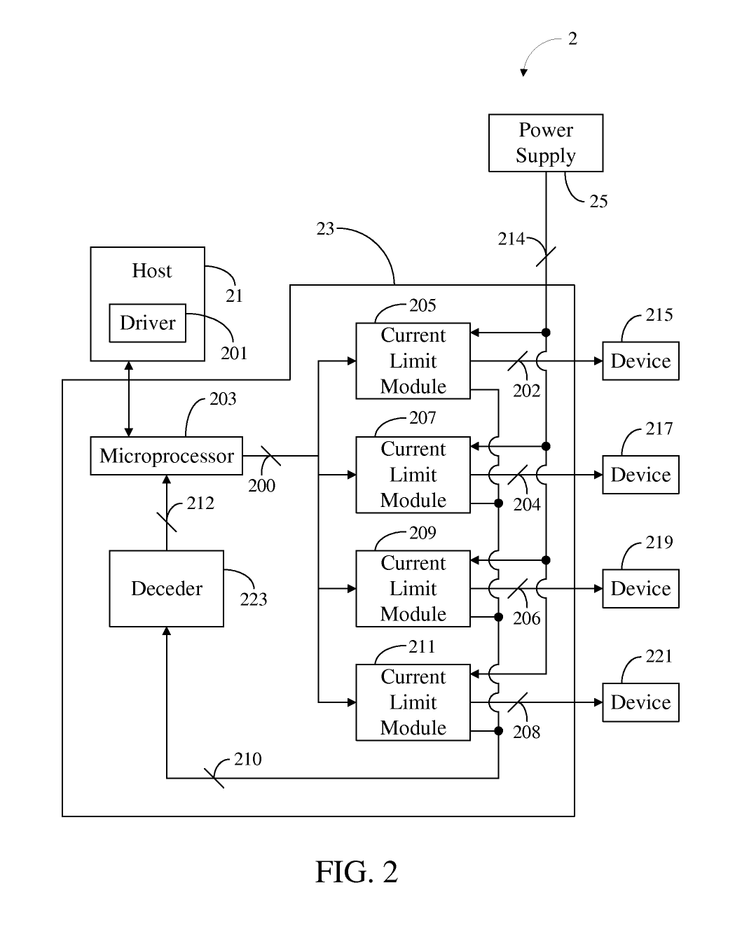

A first embodiment of the present invention is a system 2 for testing a plurality of devices with a connection interface as illustrated in FIG. 2. The connection interface is the USB connection interface or the IEEE 1394 connection interface, etc. For simplification, four devices (devices 215, 217, 219, and 221) are illustrated. The system 2 comprises a host 21, a testing apparatus 23, and a power supply 25. The testing apparatus 23 comprises a microprocessor 203, a plurality of current limit modules 205, 207, 209, 211, and a decoder 223.

The host 201 respectively sends an enable signal 200 to the current limit module 205, 207, 209, and 211 (hereinafter referred as 205˜211) via the microprocessor 203 to enable devices 215, 217, 219, and 221 (hereinafter referred as 215˜221).

Each of the devices 215˜221 has a connection interface. The devices 215˜221 are respectively connected to the corresponding current limit module 205˜211 through the corresponding connection interfaces. The current limit modules 205˜211 can respectively control the current passing through the devices 215˜221. The power supply 213 provides a 5-volt voltage 214 to the device 215 via the current limit module 205, to the device 217 via the current limit module 207, to the device 219 via the current limit module 209, and to the device 221 via the current limit module 211. During the test, the host 201 respectively sends testing signals 202, 204, 206, 208 to the devices 215˜221 via the microprocessor 203 and the current limit module 205˜211.

When the devices 215˜221 are tested, currents of the devices 215˜221 will be assessed individually. If there is an over current that passes through one of the devices 215˜221, such as the device 217, the corresponding current limit module, such as the current limit module 207, will send an over current signal 210 to the decoder 223. After decoding the over current signal 210, the decoder 223 will send a decoding signal 212 to the microprocessor 203. Then, the microprocessor 203 registers the test failure of the device 217 through the decoding signal 212. The information of the device failure will be shown on the host 201. At the same time, the testing of the device 217 will be stopped by the microprocessor 203. To be more specific, the microprocessor 203 cuts off the voltage 214 provided by the power supply 213 via the current limit module 207, so that the fault device 217 can be removed, while the testing of other devices continue.

If the currents of the devices 215˜221 are normal, a driver 201 of the host 21 will update firmware (not shown) of the devices 215˜221 via the testing apparatus 23 individually, and identify which of the devices 215˜221 is a failed device. Similarly, the driver 201 of the host 21 will execute reading/writing tests of the devices 215˜221 via the testing apparatus 23 individually, and identify which of the devices 215˜221 is a failed device.

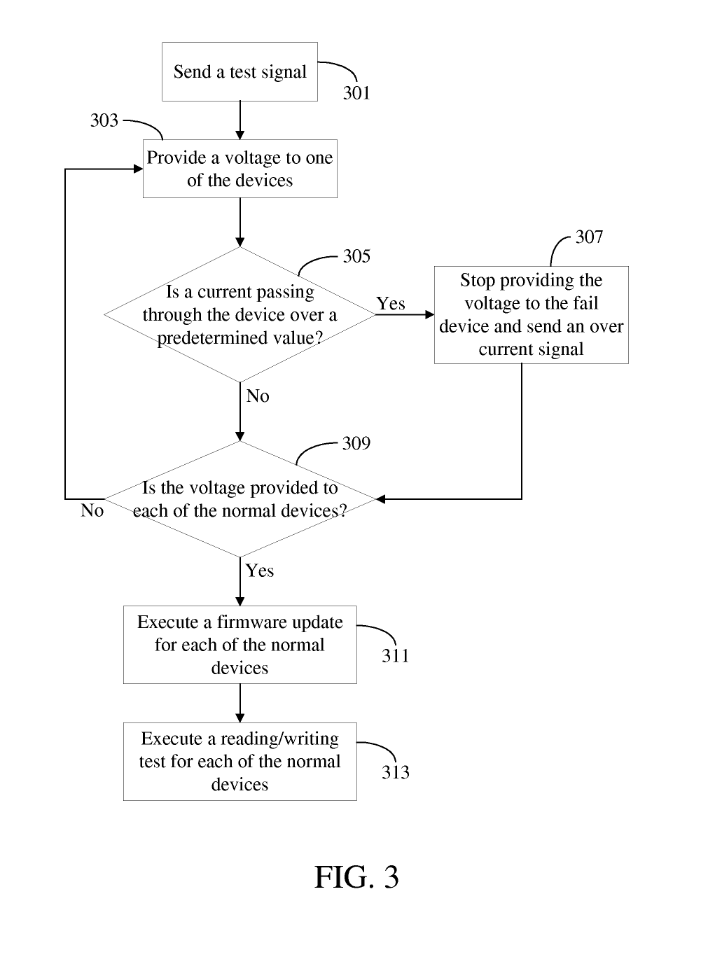

A second embodiment of the present invention is a method for testing a plurality of devices with connection interfaces. The interfaces include the USB connection interfaces or the IEEE 1394 connection interfaces, etc. The method is applied to the testing system 2 as described in the first embodiment by a computer program that controls the testing system 2. The corresponding flow chart is shown in FIG. 3.

First, step 301 is executed for sending a test signal to start testing of a plurality of devices. Then, step 303 is executed for providing a voltage to one of the devices after receiving the test signal. Next, step 305 is executed for determining whether a current passing through the device which receives the voltage is over a predetermined value or not. If yes, the device is identified as a fail device and then step 307 is executed for stopping providing the voltage to the device and sending an over current signal. Then, step 309 is executed for determining whether the voltage is provided to each of the normal devices or not. If no, step 303 is executed again for providing a voltage to another device of the devices.

If the current passing through the device which receives the voltage is not over the predetermined value in step 305, the device is identified as a normal device. Then, step 309 is executed for determining whether the voltage is provided to each of the normal devices or not.

If the voltage is provided to each of the normal devices in step 309, step 311 is executed for executing a firmware update for each of the normal devices. Finally, step 313 is executed for executing a reading/writing test for each of the normal devices.

In addition to the operations depicted in the second embodiment as shown in FIG. 3, the second embodiment can also execute all the operations of the first embodiment. Those skilled in the art can understand the corresponding steps or operations of the second embodiment by the first embodiment, and thus, no unnecessary detail is given further.

Accordingly, the present invention is capable of testing a plurality of devices without limiting the number of devices being tested. All of the devices can be tested at the same time. Consequently, the present invention can reduce the cost of test and the test will not be interrupted by one device failure.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A testing apparatus for testing at least one device with a connection interface, comprising:
a microprocessor; and
at least one current limit module, electrically connected to the microprocessor and the at least one device, for providing a voltage to the at least one device;
wherein when a current passing through the at least one device is greater than a predetermined value, the at least one current limit module stops providing the voltage to the at least one device and sends an over current signal to the microprocessor.

2. The testing apparatus as claimed in claim 1, further comprising a decoder, wherein the microprocessor receives the over current signal via the decoder for identifying the at least one device as a fail device.

3. The testing apparatus as claimed in claim 1, wherein the connection interface is one of a USB connection interface and an IEEE 1394 connection interface.

4. A system for testing at least one device with a connection interface, comprising:
a host for sending a test signal;
a testing apparatus, electrically connected to the host and the at least one device, for providing a voltage to the at least one device after receiving the testing signal; and
a power supply for providing the voltage to the testing apparatus;
wherein when a current passing through the at least one device is greater than a predetermined value, the testing apparatus stops providing the voltage to the at least one device and sends an over current signal to the host.

5. The system as claimed in claim 4, wherein the testing apparatus comprises:
a microprocessor; and
at least one current limit module, electrically connected to the microprocessor, the at least one device, and the power supply, for providing the voltage to the at least one device;
wherein when the current passing through the at least one device is over a predetermined value, the at least one current limit module stops providing the voltage to the at least one device and sends the over current signal to the host via the microprocessor.

6. The system as claimed in claim 5, wherein the testing apparatus further comprises a decoder, wherein the microprocessor receives the over current signal via the decoder for identifying the at least one device as a fail device.

7. The system as claimed in claim 4, wherein the connection interface is one of a USB connection interface and an IEEE 1394 connection interface.

8. The system as claimed in claim 4, wherein the host comprises a driver for updating a firmware of the at least one device via the testing apparatus.

9. The system as claimed in claim 8, wherein when the at least one device fails in the updating of the firmware, the at least one device is identified as a fail device.

10. The system as claimed in claim 4, wherein the host further comprises a driver for executing a reading/writing test of the at least one device via the testing apparatus.

11. The system as claimed in claim 10, wherein when the at least one device fails in the reading/writing test, the at least one device is identified as a fail device.

12. A method for testing at least one device with a connection interface, comprising the steps of:
sending a test signal;
providing a voltage to the least one device after receiving the test signal;
stopping providing the voltage to the at least one device when a current passing through the at least one device is over a predetermined value; and
sending an over current signal.

13. The method as claimed in claim 12, further comprising the step of:
identifying the at least one device as a fail device according to the over current signal.

14. The method as claimed in claim 12, wherein the connection interface is one of a USB connection interface and an IEEE 1394 connection interface.

15. The method as claim in claim 12, further comprising the step of:
executing a firmware update for the at least one device when the current passing through the at least one device is not over the predetermined value.

16. The method as claim in claim 15, further comprising the step of:
executing a reading/writing test for the at least one device.
